(19) United States
(12) Patent Application Publication
(10) Pub. No.: US 2024/0119374 A1
(43) Pub. Date: Apr. 11, 2024

(54) SYSTEMS AND USER INTERFACES FOR CANVASSING ANALYSIS

(71) Applicant: Grassroot Technologies, LLC (DBA Vottiv), Provo, UT (US)

(72) Inventors: Bryce Jackson LUND, Provo, UT (US); Jesse Eric SANDSTROM, Vineyard, UT (US)

(21) Appl. No.: 17/962,336

(22) Filed: Oct. 7, 2022

(51) Int. Cl. G06Q 10/06; G06F 3/0482

(52) U.S. Cl. CPC G06Q 10/063114; G06F 3/0482

(57) ABSTRACT

Techniques for generating a canvass are disclosed. A canvass user interface is generated. This interface has a particular visual layout designed to enable efficient refinement of demographic data to identify targeted individuals and to facilitate canvassing events. Refining the demographic data enables a list of targeted individuals to be identified, where these targeted individuals are selected to be canvassed. Various canvassing tasks are generated for the canvass. An executable token is also generated. This token can be used to link a client device to a particular canvass associated with the executable token. Data is collected via the client device. That data is analyzed, and metrics associated with that data are displayed in the user interface.

### BACKGROUND

The term “canvassing” refers to an action in which supporters travel around a selected location and try to either persuade targeted individuals to join a cause or to obtain information detailing how those targeted individuals feel about that cause. Traditional techniques for canvassing have been highly laborious, costly, and generally inefficient. What is needed, therefore, is an improved technique for facilitating canvassing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture that facilitates the disclosed canvassing operations.

FIG. 2 illustrates an example user interface (UI) showing a canvass.

FIG. 3 illustrates an example UI showing an action for creating a new canvass.

FIG. 4 illustrates an example showing various filtering operations that can be performed when creating a canvass.

FIG. 5 illustrates some further filtering operations.

FIG. 6 illustrates some further filtering operations.

FIG. 7 illustrates some further filtering operations.

FIG. 8 illustrates an option for specifying an objective, or rather a set of tasks, for a canvass.

FIG. 9 illustrates an option for specifying additional details for the canvass.

FIG. 10 illustrates an option for providing a description when attempting to obtain signatures.

FIG. 11 illustrates the visualization of the canvass in the UI's dashboard.

FIG. 12 illustrates how an executable token can be generated to enable client devices to join the canvass.

FIG. 13 illustrates a client-side user interface. The executable token can be entered into this UI to link the client device to the canvass.

FIG. 14 illustrates further features of the client-side UI.

FIG. 15 illustrates further features of the client-side UI.

FIG. 16 illustrates a canvass summary page in the configuration UI.

FIG. 17 illustrates further features of the client-side UI.

FIG. 18 illustrates further features of the client-side UI.

FIG. 19 illustrates an option for obtaining signatures on the client-side UI.

FIG. 20 illustrates an option for obtaining additional requests via the client-side UI.

FIG. 21 illustrates an option for configuring a group communication.

FIG. 22 illustrates further options for configuring the group communication.

FIG. 23 illustrates a flow chart of an example method for facilitating various canvassing operations.

FIG. 24 illustrates an example computer system that can be configured to perform any of the disclosed operations.

### DETAILED DESCRIPTION

Embodiments disclosed herein relate to systems, devices, and methods for (i) providing a canvass user interface that has a particular visual layout designed to enable efficient refinement of demographic data to identify targeted individuals and to facilitate canvassing events, (ii) generating a set of canvass tasks, and (iii) generating an executable token that links a client device to a particular canvass associated with the executable token.

Some embodiments generate or access a canvass. The generation or access of this canvass includes accessing a set of demographic data for a preselected population sector. As a part of generating or accessing the canvass, the embodiments visually display a user interface (UI) that has a visual layout designed to enable refinement of the set of demographic data. This refinement results in the identification of a target set of individuals within the preselected population sector. These targeted individuals are included in the canvass. Beneficially, the visual layout includes a first set of selectable UI elements that, when selected, generate parameters that operate on the set of demographic data to filter the set of demographic data (e.g., to refine the list of target individuals). As a result, a filtered set of data is generated (e.g., a refined listing of individuals), and the filtered set of data is associated with the canvass. As indicated above, the filtered set of data identifies the target set of individuals.

The visual layout of the UI further includes a second set of selectable UI elements that, when selected, generate a set of one or more canvassing tasks for the canvass. These tasks can be performed against the targeted individuals. The visual layout further includes a third set of UI elements that display metrics for the canvass. The displayed metrics visually indicate a respective completion status for each canvassing task in the set of canvassing tasks. That is, as the targeted individuals are canvassed based on the tasks, the metrics will be updated to reflect these actions.

Optionally, the visual layout can further include a fourth set of UI elements. This fourth set includes one or more of: a first option that facilitates transmission of a short message service (SMS) message being delivered to specific individuals; a second option that facilitates transmission of an email message being delivered to the specific individuals; a third option that facilitates transmission of physical mail being mailed to the specific individuals; or a fourth option that facilitates posting of advertisements to the specific individuals.

The embodiments generate an executable token that is shareable with one or more client devices (e.g., devices of supporters for the canvass). The executable token is structured such that, when executed by a client device, the client device is provided access to the set of one or more canvassing tasks for the canvass as well as the set of targeted individuals. The embodiments also receive completion information from a particular client device that executed the executable token. The completion information reflects completion statuses for the canvassing tasks as they are performed with respect to the targeted individuals. The embodiments update the third set of UI elements that display the metrics. This updating process is based on the received completion information.

### Examples of Technical Benefits, Improvements, And Practical Applications

The following section outlines some example improvements and practical applications provided by the disclosed embodiments. It will be appreciated, however, that these are just examples only and that the embodiments are not limited to only these improvements.

The disclosed embodiments bring about significant benefits, advantages, and practical improvements to the technical field of user interface generation and canvassing implementation. In particular, the embodiments describe a user interface structured to have a particular visual layout. This visual layout improves how a user interacts with a computer system, thereby enabling the efficient use of that computer system by the user. The layout is designed to enable quick and easy inputting of data and access to various metrics that are computed. The user interface also facilitates a widespread coordination effort to canvass the targeted individuals. Without the disclosed user interfaces, canvassing actions are highly laborious, inefficient, and slow.

The disclosed embodiments also significantly improve canvassing operations. As used herein, the term “canvass” generally refers to a computing data structure that is generated by the disclosed embodiments. This data structure includes information describing the set of targeted individuals. The data structure further includes information regarding a set of canvassing tasks that are to be completed with respect to the targeted individuals. The data structure further includes completion information indicating a completion status of those tasks.

The disclosed embodiments are advantageous in that they enable a canvass to be generated. The embodiments also improve various canvassing processes by providing a unified and intuitive interface that can be used to define tasks associated with the canvass and that can be used to input data obtained while performing the canvassing tasks. Accordingly, these and numerous other benefits will now be described throughout the remaining portions of this disclosure.

### Example Architecture

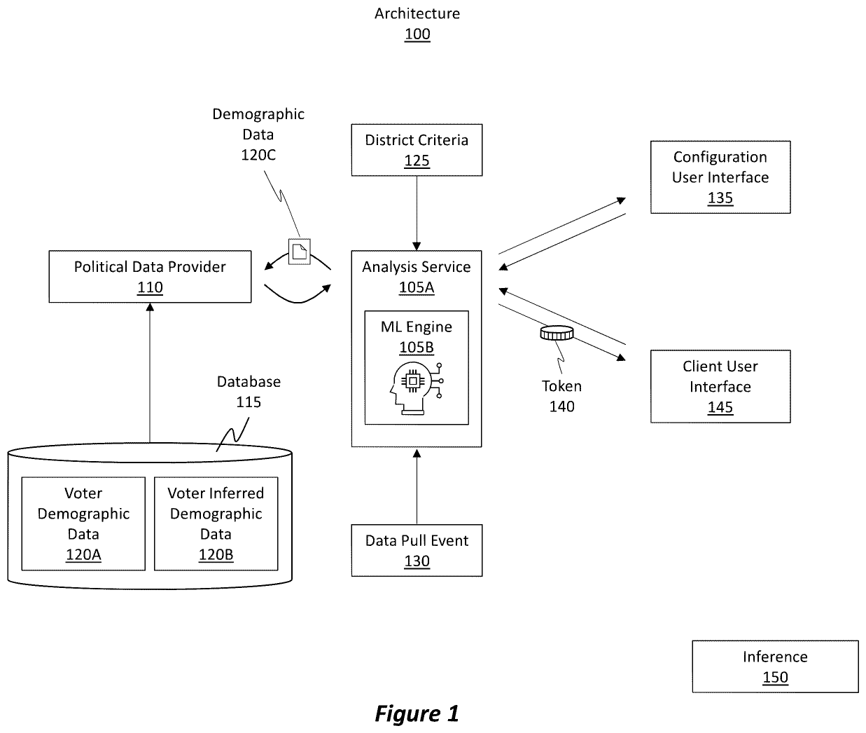

Attention will now be directed to FIG. 1, which illustrates an example architecture 100 that can be used to implement the disclosed operations, such as by generating or accessing the canvass data structure. If a new canvass is created, then the embodiments facilitate the generation of that canvass. If an existing canvass is further interacted with, then the embodiments facilitate the access of that canvass.

Architecture 100 is shown as including an analysis service 105A. Optionally, this analysis service 105A can be a cloud-based service operating in the cloud. Alternatively, this analysis service 105A can be a local service operating on a local device. In some cases, the analysis service 105A can be a hybrid combination of both a cloud service and a local service.

In some implementations, the analysis service 105A includes a machine learning (ML) engine 105B. As used herein, reference to any type of machine learning may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The analysis service 105A is able to generate a data structure (called a “canvass”) that identifies a targeted set of individuals and that lists various tasks that are to be completed relative to those targeted individuals. This data structure can be stored locally on a device or remotely, such as perhaps in the cloud.

When generating the canvass, the analysis service 105A communicates with a political data provider 110. A political data provider 110 refers to a type of provider that obtains and aggregates political polling information from or about the residents of a particular region. In some cases, this political data provider 110 is a third party provider relative to the analysis service 105A. In some cases, the political data provider 110 is an integrated part of the analysis service 105A.

In any event, the political data provider 110 is able to access a database 115 comprising voter demographic data 120A. This voter demographic data 120A represents data indicative of how voters or individuals within a region feel toward various political issues, candidates, or topics. The voter demographic data 120A is structured data in that it is associated with a quantifiable score or metric reflecting how individuals feel toward a particular issue.

Regarding the “structure” of the data, the data can be structured using any type of structuring format, such as perhaps a star ranking format, a 0-10 ranking format, and so on. Any type of quantification technique can be used to provide structure to the data. This data can be collected via surveys, political polling, or any other technique.

In some cases, the voter demographic data 120A can additionally include unstructured data in the form of expressive text describing individuals' thoughts and feelings. Optionally, a natural language processing (NLP) engine can analyze the unstructured text and provide structure to it, such as by assigning a ranking value to the text. For instance, the following text “I hate Tom” can be analyzed by the NLP engine. Based on the detected sentiment in the text, the NLP engine might give this text a ranking of 0 to indicate that whoever expressed that statement does not like Tom. In this manner, assigning the ranking operates to provide structure to the text.

The voter demographic data 120A can be organized based on locality or region. An entire country can be polled, and the voter information for the individuals in that country can be included in the voter demographic data 120A. The data can be organized based on the locations of the individuals, as organized based on voting boundaries (e.g., precincts or other defined political boundaries). Accordingly, the voter demographic data 120A can represent specific thoughts, feelings, and attitudes individuals have toward specific topics, individuals, or any type of issue. The voter demographic data 120A can also include answers to surveys, voting trends, and other information.

Examples of such topics can include, but certainly are not limited to, the following: (1) how males feel about a particular political issue, (2) how females feel about that same issue, (3) how republican gun owners feel about the issue, (4) how democratic city dwellers feel about the issue, (5) how rural individuals feel about the issue, and so on, without limit. Any type of political polling data can be obtained. That data can be organized or at least marked with metadata reflecting characteristics or demographics of the individuals who provided the data. For instance, if a person was pro-gun, the embodiments are able to store metadata about that person along with that person's political viewpoint. This metadata might include the following demographic information about the person: the person is a man, he identified as being a Republican, he lives in a rural area in Texas, and he is a gun owner. The characteristics of the individual are referred to as demographic information about that person. That demographic information can be stored in the voter demographic data 120A along with the individual's actual political persuasion towards a topic.

In some implementations, the database 115 can further include voter inferred demographic data 120B. The voter inferred demographic data 120B refers to data that is inferred, perhaps by the political data provider 110 or perhaps by the ML engine 105B, based on the voter demographic data 120A. For instance, an initial base set of voter information can be obtained (e.g., perhaps the voter demographic data 120A). The embodiments are able to analyze this base set of information and then generate one or more inferences based on that data. As one example, the embodiments might obtain the following information: a particular voter lives in a rural Texas area and is identified as being a republican. Based on that information, the embodiments can infer that it is highly likely that this individual is pro-gun.

On the other hand, consider the scenario where the embodiments obtain the following information: a young individual living in an urban area identifies as being a democrat. The embodiments can infer that it is highly likely that this individual is likely not pro-gun. These inferences can be associated with a confidence metric that is generated by the ML engine 105B. Furthermore, these inferences can be included in the voter inferred demographic data 120B. The embodiments are able to generate any number of inferences based on the voter demographic data 120A. Inferences that have a confidence value that exceeds a predefined confidence threshold can be included in the voter inferred demographic data 120B.

During the generation of a canvass, the analysis service 105A is able to receive information regarding a particular district or location, as shown by district criteria 125. After the district or location is identified, the analysis service 105A can obtain all demographic information for that location. During generation of the canvass, additional parameters can also be obtained in order to further refine or filter the obtained data. In any event, the initial refinement of the voter demographic data 120A and/or the voter inferred demographic data 120B is based on the specified location that is of interest for a canvass.

As shown in FIG. 1, the analysis service 105A is able to receive, obtain, or otherwise access the demographic data 120C, which includes the voter demographic data 120A and the voter inferred demographic data 120B. As mentioned above, the obtained data is initially filtered by the specified location that is associated with a canvass. Additional parameters, as will be described in more detail later, can also be used to further refine the data. This data identifies a set of targeted individuals. The analysis service 105A can access this data in response to one or more events occurring, as shown by the data pull event 130.

As mentioned, a “canvass” refers to a data structure that is organized to track various tasks that can be performed for an identified target set of individuals. As an example, one task can include inquiring as to whether those individuals like their current political representative. As another example, a task can include acquiring signatures in support of a particular cause. It is typically the case that a canvass is generated for a particular district or region.

The act of creating a new canvass constitutes an event that will trigger the analysis service 105A to acquire the demographic data 120C. Notably, the amount of data that is included in the demographic data 120C is typically highly expansive, even when it is initially filtered based on the specified location for the canvass. That is, it is typically the case that the only initial filtering parameter used to filter the data in the database 115 is based on a defined location, district, precinct, or region.

Stated differently, the embodiments access the database 115, but then the embodiments filter the data based at least on the specified location. Optionally, the embodiments retain the filtered data locally. As a result, all of the information related to the voters in that location (both actual data and inferred data) is obtained. Data from other locations is not obtained. During the generation of the canvass, additional filtering parameters can also be specified. The embodiments can execute those parameters to further refine the data and to store it as a part of the canvass.

Accordingly, the generation of a new canvass triggers a data pull event 130, and the analysis service 105A obtains all of the political data (both actual and inferred) for individuals residing within a defined location, where that location is initially the only filtering parameter used to filter the data in the database 115. All of that data can be stored locally in a repository. That data can be further refined using additional parameters, and the resulting filtered data can then be associated or linked with a particular canvass. Thus, in some embodiments, a larger set of data is stored locally for a particular location, and a smaller set of data is also stored locally for a canvass that has multiple parameters (one of which is the location). In some embodiments, only a single set of data is stored locally for the location. When the canvass is accessed, the analysis service 105A can execute the parameters against the locally stored version of the data without having to generate an additional copy.

After the initial generation of the canvass, the analysis service 105A will periodically pull updated information from the political data provider 110. For instance, the analysis service 105A can pull updated data each new calendar quarter. Thus, a timing factor can trigger a data pull event 130 in order to receive updated information for the canvass.

It should be noted how the political data provider 110 can continuously or perhaps periodically update the information in the database 115. As new data emerges or is acquired, that new data can be included in the database 115. The analysis service 105A can access this updated data when a new data pull event 130 is triggered. In some instances, a new data pull event 130 can be manually triggered by a user at any time. In some instances, automatic pull events are triggered based on a defined period or frequency. This frequency can be based on the calendar year or based on the creation date of a canvass.

The analysis service 105A is able to surface or provide a configuration user interface 135. This UI can be used to create and/or configure a new or existing canvass. Additionally, the analysis service 105A can generate a shareable, executable token 140 that is linked with a canvass. This token 140 can be shared with any number of client devices to link those devices to the created canvass.

The analysis service 105A can also provide a client user interface 145. The client user interface 145 can be used to input the token 140. The client user interface 145 then provides a portal for a volunteer, staffer, or supporter to help complete the tasks that have been defined for the canvass. Access to that canvass is provided and authenticated using the token 140.

The analysis service 105A, or perhaps the ML engine 105B, can also make inferences, as shown by inference 150, based on data that is ingested from the various client devices. Any number of client devices can be linked to a canvass, and those client devices can be used to obtain information from specific individuals who have been targeted for inclusion in the canvass. As more information is ingested and received by the analysis service 105A from the various different client devices, the analysis service 105A can engage in perpetual learning and refinement to determine what activities produce effective results and what demographics can be further targeted. The analysis service 105A can thus generate any number of inferences (e.g., inference 150) based on the ingested data.

Optionally, locally saved versions of the voter demographic data 120A and/or the voter inferred demographic data 120B (i.e. versions saved at the analysis service 105A) can be updated based on a predefined event. That predefined event can include the generation of a new canvass. That predefined event can include the elapse of a predefined amount of time since a canvass has been created. For instance, the data may be updated three months (or any other selected amount of time) after a canvass is generated. The data can then subsequently be periodically updated every three months thereafter.

### Example User Interfaces

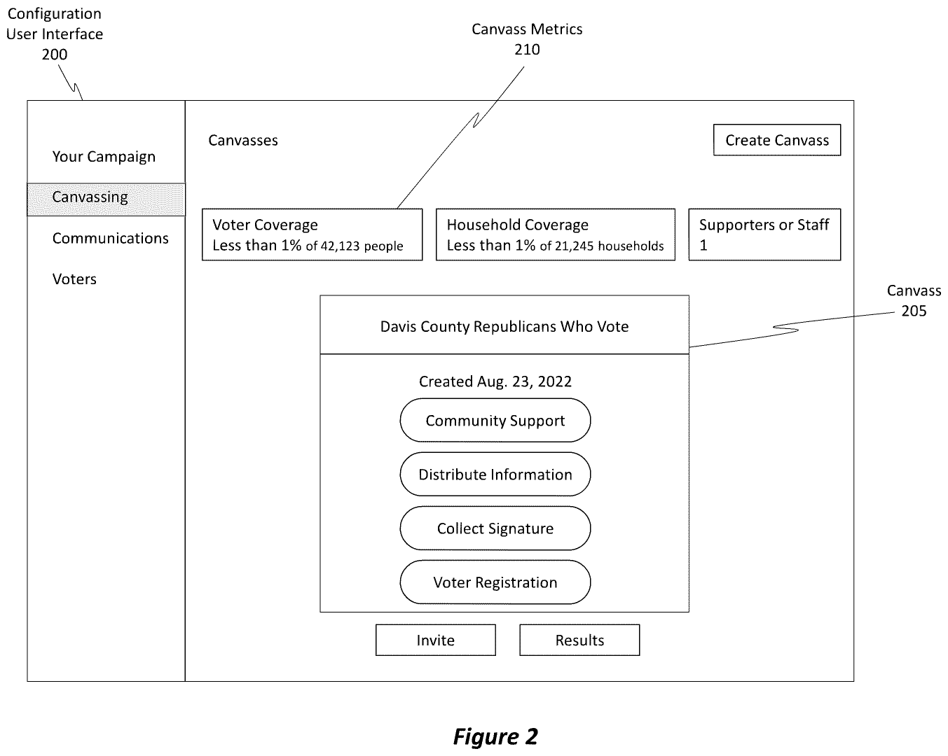

Having just described some of the various operations involved in the creation and use of a canvass, attention will now be directed to FIGS. 2 through 22. These figures illustrate various different user interfaces that can be provided to facilitate the disclosed operations.

FIG. 2 shows an example configuration user interface 200, which is representative of the configuration user interface 135 from FIG. 1. The configuration user interface 200 can be displayed for an administrator who is tasked with creating and configuring a new canvass.

Currently, the configuration UI 200 is showing a dashboard that is displaying an already-created canvass 205 entitled “Davis County Republicans Who Vote.” The UI is displaying the creation date for the canvass 205.

Also, various tasks or objectives have been created for this canvass 205, as shown by the following tabs: Community Support, Distribute Information, Collect Signatures, and Voter Registration. The UI is also showing various canvass metrics 210 associated with the canvass 205.

Recall, when the canvass 205 was first created, a defined geographic region was selected (e.g., a voting district, precinct, or region), and the analysis service initially obtained all of the voter demographic information for that selected region. During generation of the canvass 205, the user creating the canvass then imposed various additional filtering parameters to narrow the number of individuals who are to be included or targeted by this canvass. For instance, based on the name of the canvass 205, the parameters were likely “Davis County” residents, “Republicans” within that county, and “Individuals Who Voted” within that county. Although many thousands of individuals might reside in Davis County, the combination of the filtering parameters reduced the number of individuals who are being targeted by this canvass 205 to now be 42,123 people and 21,245 households, as shown by the canvass metrics 210. Currently, a single volunteer/supporter or staff member is linked with canvass 205.

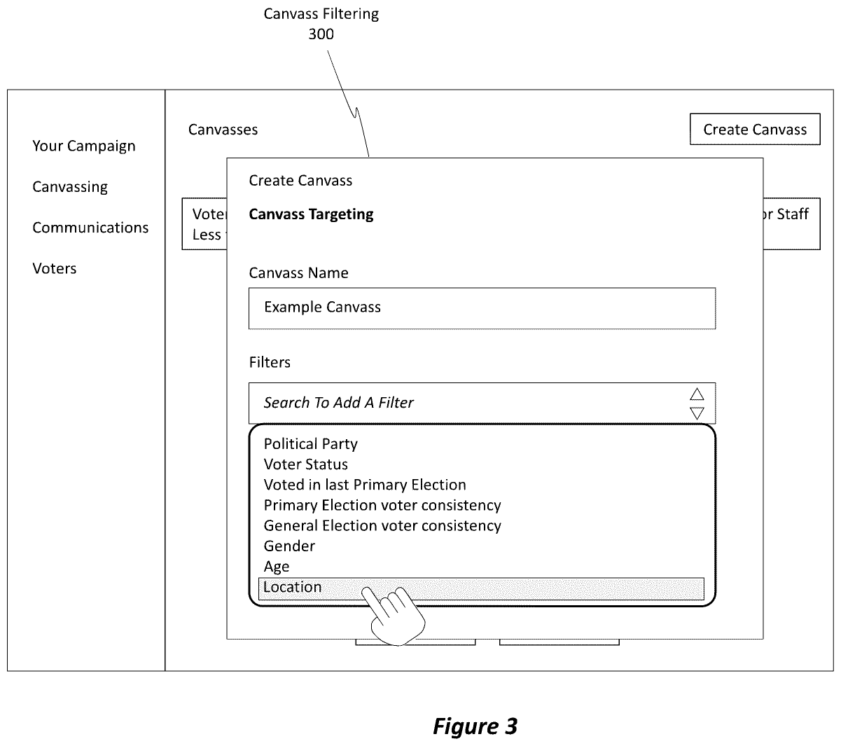

FIG. 3 shows an example UI that can be displayed when creating a new canvass. For instance, in response to the “Create Canvass” UI element being selected, the canvass filtering 300 menu will be displayed. Within this menu, the user can enter the name of the canvass; in this case, the name is “Example Canvass.”

The user can then select one or more different filtering parameters. A non-exhaustive list of parameters is shown in FIG. 3 and includes parameters such as political party, voter status, voted in last primary election, primary election voter consistency, general election voter consistency, gender, age, and location.

In some embodiments, all canvasses created for a campaign will be confined to only pull data from the district in which a particular candidate is running. This option can be automatic and does not require any location input from a user when creating a canvass. Subsequent “location” based filters can be displayed in the “Create Canvass” popup, and that location filter can be an optional filter to further restrict the location. For example, a US Senator's district is the entire state of Utah. If a user creates a canvass with no filters, it will include all voters in Utah. However, the location filter will offer options such as every county, city, or school district within the district boundaries. So the senator could create a canvass to specifically target Davis county or Salt Lake City. For smaller districts, this can work the same way. A person running for a position that encompassed all of Utah county could use the location filter to narrow down to any city or school district within that county district.

Accordingly, in some embodiments, though not necessarily all, the first required parameter is the “Location” parameter so that the analysis service can pull the data from the political data provider. To be clear, in some embodiments, an initial baseline filtering parameter is required to be the location parameter. In the scenario shown in FIG. 3, the user is shown as selecting the location filtering parameter to further refine the results based on a more granular selection of the location. These parameters can be thought of as “keys,” and the user will then subsequently enter “values” for those “keys.”

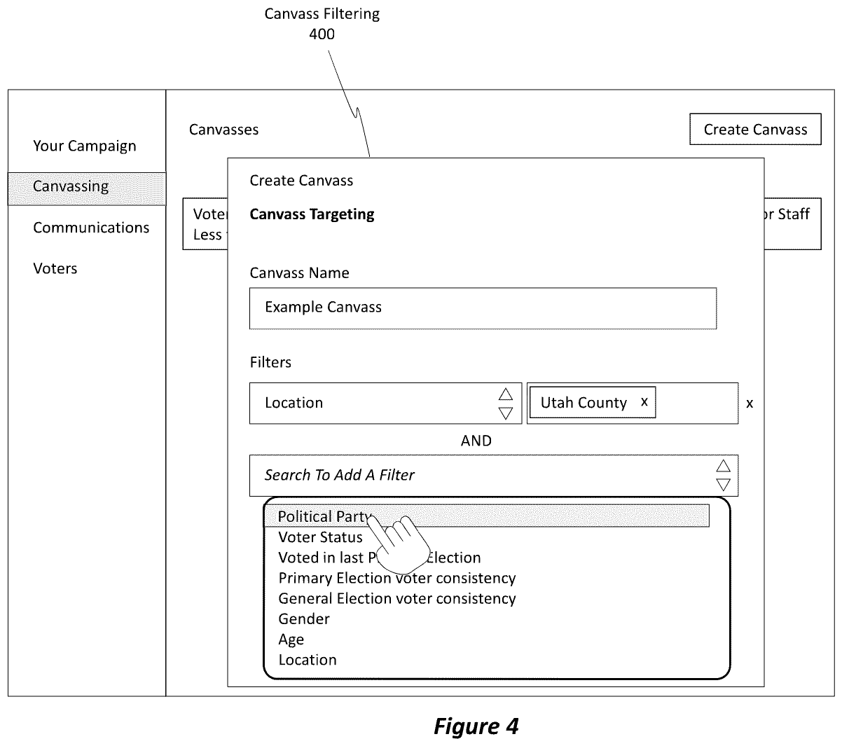

FIG. 4 again shows the canvass filtering 400 menu. Notice, the user previously selected the location parameter and then entered a specific value associated with that parameter. Here, that value is “Utah County.” Based on this parameter, the analysis service is tasked with initially accessing all of the voter demographic data for Utah County.

In some embodiments, the analysis service will trigger the download or local storage of all the voter demographic data for Utah County from the political data provider. After this initial download, the analysis service can generate a separate local database for this specific canvass and then populate that database with data based on additional parameters entered by the user. Thus, a larger (e.g., master) database of information (i.e. the one that includes all of the voter demographic data for Utah County) can be stored, and a smaller database of information (i.e. one that is specifically based on the entire combination of entered parameters for this canvass) can be stored.

In a different embodiment, instead of generating a separate, canvass-specific database (i.e. one that is separate from the Utah County database), the embodiments may simply retain the parameters for this canvass and then execute those parameters against the downloaded Utah County data. Some embodiments collect all of the parameters during the generation of the canvass and then use these parameters to obtain the information from the political data provider's database.

In FIG. 4, the user has opted to use the UI to add an additional filtering parameter. Notice, the conjunction “AND” is between the “Location” parameter and the next parameter. A list of parameters is currently displayed in a drop-down menu. The user can select any one of these parameters. In this case, the user is shown as selecting the “political party” parameter. The logical AND combination of the location parameter and the political party parameter will then be used to filter and refine obtained voter demographic data.

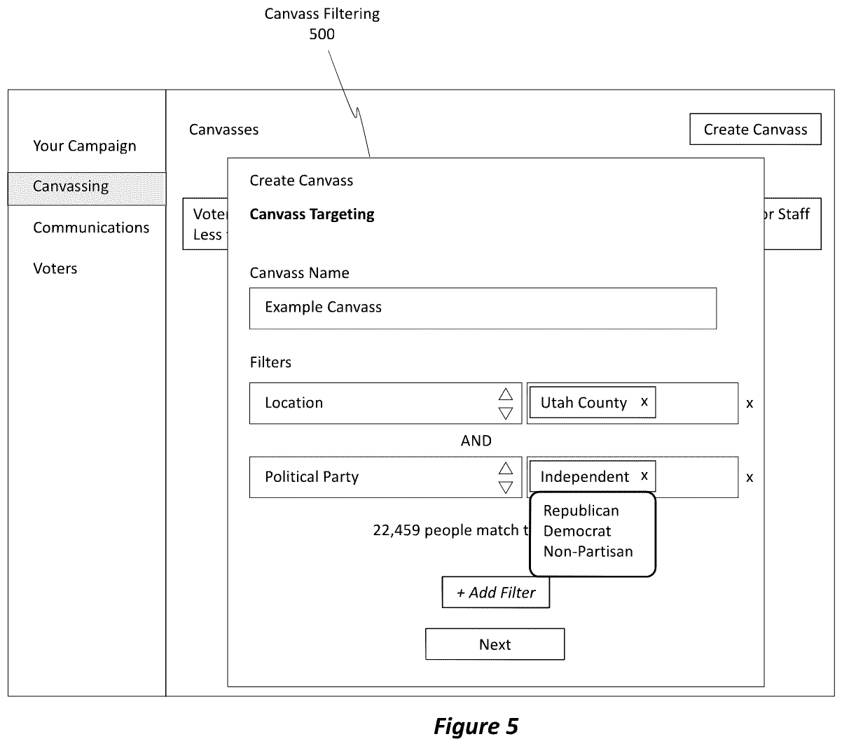

FIG. 5 again shows the canvass filtering 500 menu. Notice, the user has entered a specific value for the political party parameter. In this case, the value is “Independent” for the political party. It should be noted how multiple values can be entered for each filtering parameter. For instance, both “Independent” and “Non-Partisan” can optionally be selected. Thus, in terms of key-value pairings, one key can be associated with multiple values.

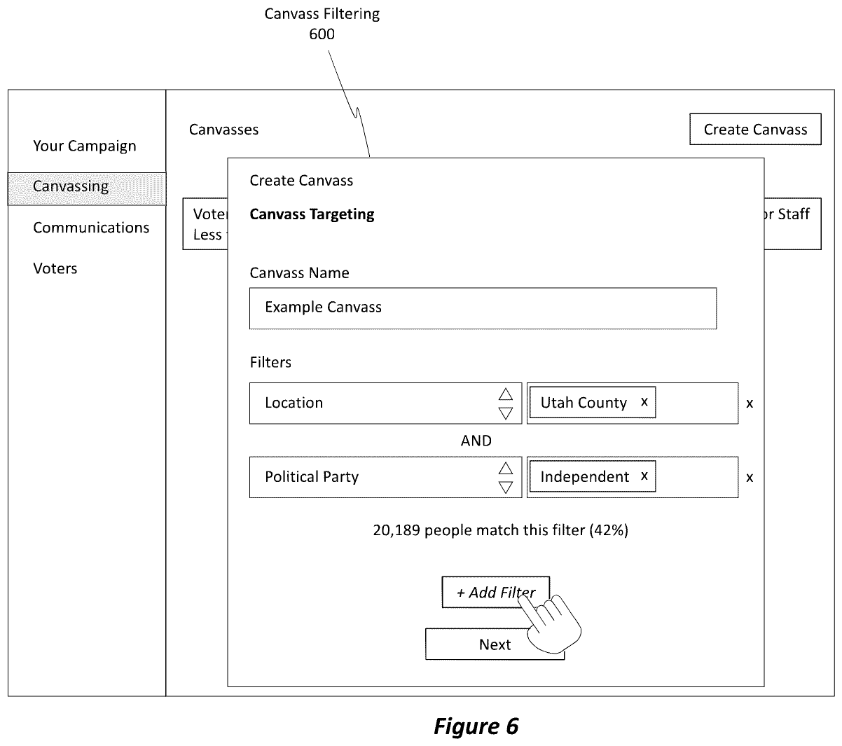

FIG. 6 again shows the canvass filtering 600 menu. Here, the user is selecting the add filter option to add yet another filtering parameter. The canvass filtering 600 menu also shows the number of people (within the defined location) who match the filter, as well as a percentage of the total population in that location. That is, the percentage indicates the relationship between the number of people who are targeted by the parameters and the total number of people in the specified location.

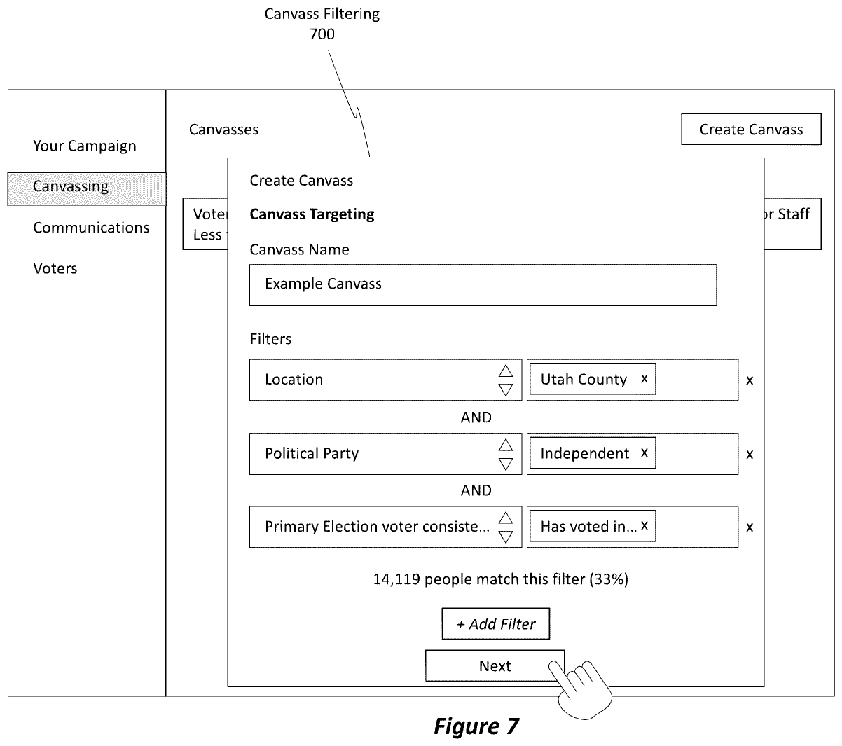

FIG. 7 again shows the canvass filtering 700 menu. In this scenario, the user has selected the “Primary Election voter consistency” parameter and has entered a specific value for that parameter. Again, the menu is displaying the number of people who have characteristics matching the parameters of the query or filtering process as well as the percentage relative to the population as a whole.

The embodiments enable a user to enter as many filtering parameters as desired. Indeed, the number of filtering parameters is unlimited.

The filtering parameters are eventually collected and then executed against the voter demographic data and/or any inferred data that is available. This filtered data can then be stored in a repository or database that is managed by the analysis service. That is, a particular canvass can be associated with its own corresponding database of voter demographic information, where this database is populated with data that has been refined using the defined parameters. As mentioned previously, it may be the case that an initial download of all the voter demographic data for a specified location is obtained. Additional repositories or databases can then be created in addition to this initial one. Alternatively, a canvass can simply execute queries against the downloaded data.

After selecting the filters and executing the parameters, filtered data is created. This filtered data represents so-called “targeted individuals” who are identified based on the parameters that were provided. These targeted individuals are linked with the canvass. Various tasks will subsequently be defined for execution with respect to those targeted individuals.

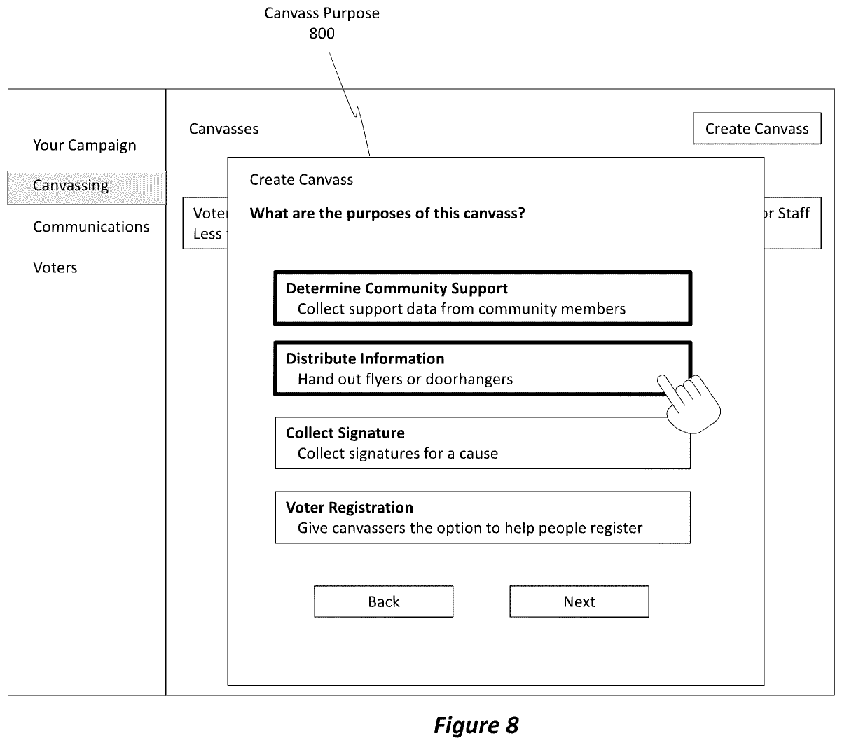

The creation of the canvass continues in FIG. 8. In particular, FIG. 8 shows how the UI is designed to display the canvass purpose 800 menu. This menu provides the user with various options for defining tasks, objectives, or goals for this canvass that is being created. Although only four tasks are illustrated in FIG. 8, one will appreciate how any number of tasks can be generated.

The listed tasks include “Determine Community Support,” “Distribute Information,” “Collect Signature,” and “Voter Registration.” The Determine Community Support task includes tasks for determining how individuals in the location feel towards a particular political topic, candidate, or other political matter or social issue. The Distribute Information task includes tasks for distributing information to individuals in the location, such as by providing them with fliers, posters, banners, one-on-one conversations, and so on. The Collect Signature task includes tasks for collecting signatures to support or reject various topics. Finally, the Voter Registration task includes tasks for assisting individuals in registering to vote.

The user can select any one or more of these different tasks; other tasks can also be defined. The tasks that are selected are emphasized in some manner, such as perhaps by having their borders bolded. Different emphasizing techniques can also be used, such as by changing the color scheme of the task's UI element, changing the shape of the UI element, changing the border style, and so on. Currently, the Determine Community Support task and the Distribute Information task are both selected.

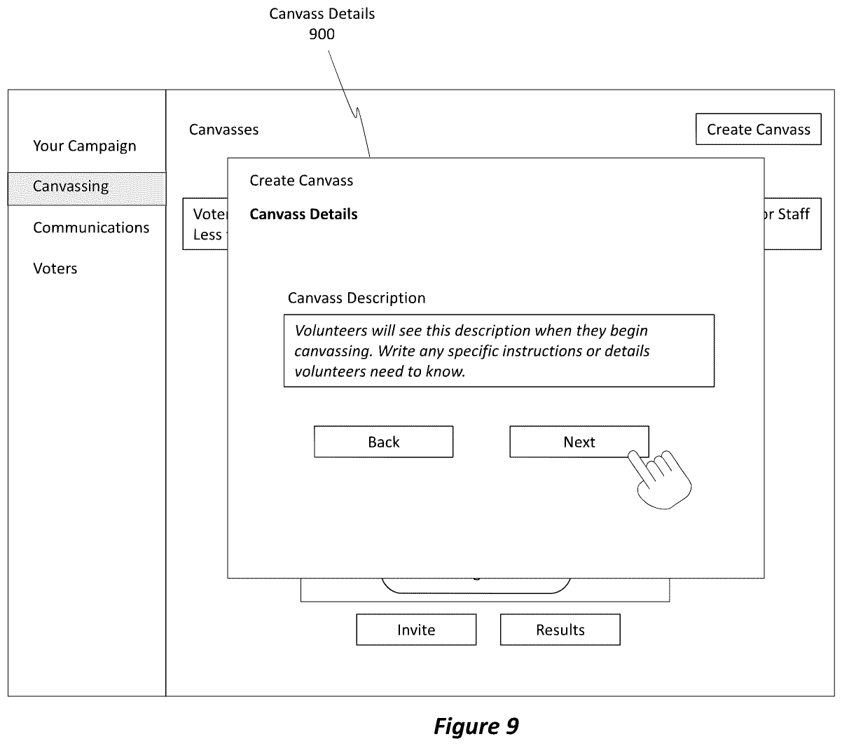

FIG. 9 shows an example canvass details 900 menu that can be displayed after selecting the various tasks. A user can enter details about the canvass, and these details will be visible to the support staff who attempt to complete the various tasks with respect to the targeted individuals.

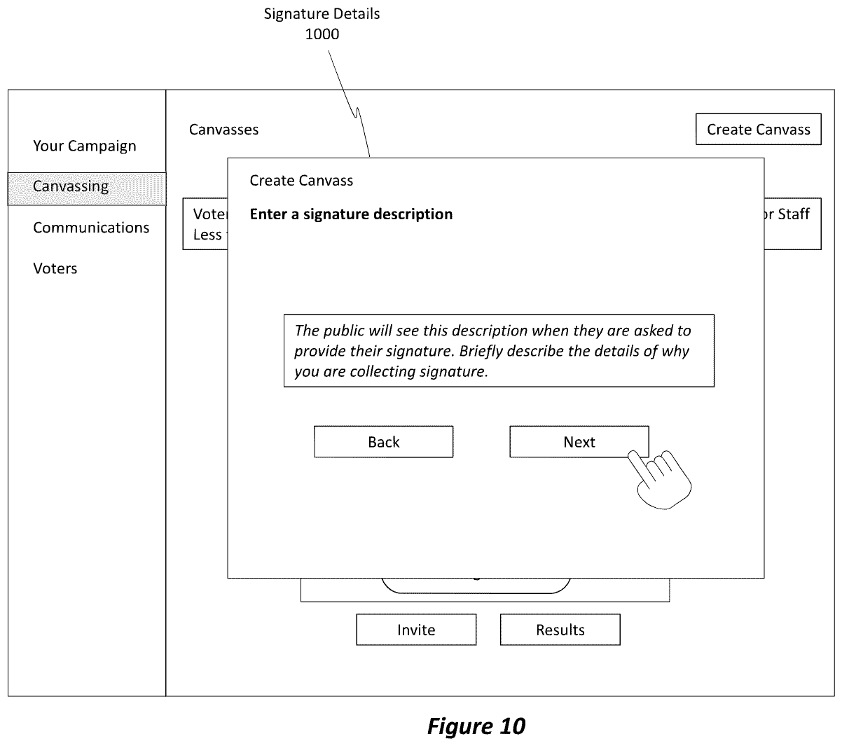

FIG. 10 shows a signature details 1000 menu. If the user previously selected the Collect Signature task, then this menu will be displayed. In this menu, the user can enter the reasons as to why signatures are being collected. These reasons can be presented to an individual who is being canvassed so that the individual can determine whether he/she would like to sign the petition or canvass.

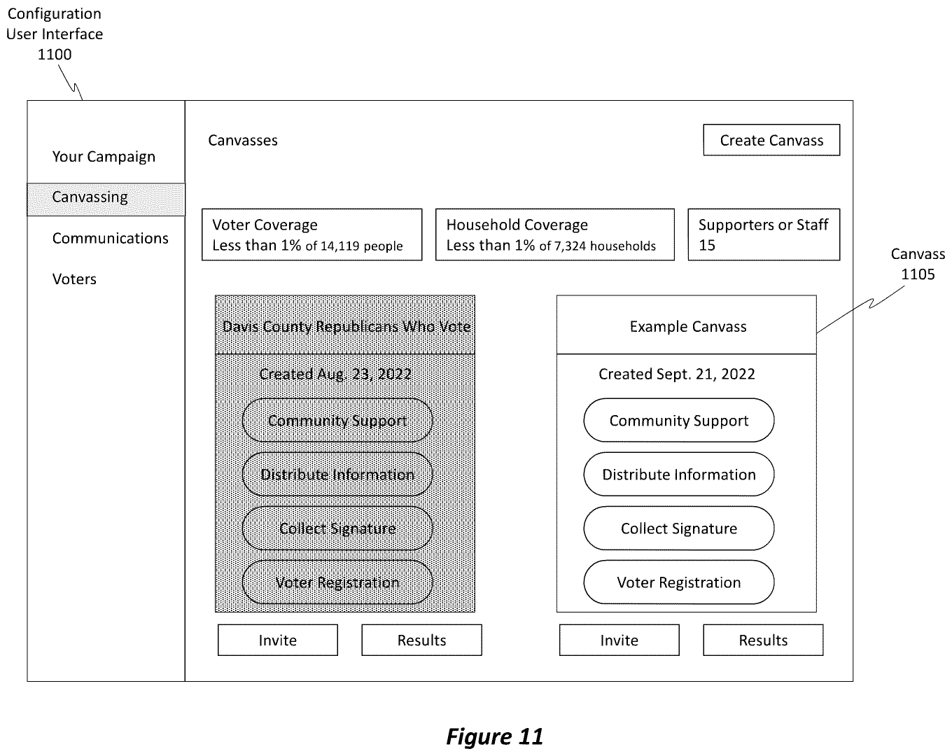

FIG. 11 again shows the dashboard of the configuration user interface 1100. The “Example Canvass” canvass 1105 is now presented along with the previous “Davis County Republicans Who Vote” canvass. The second canvass is displayed as being greyed out to illustrate how it is no longer the primary active canvass in the dashboard. Instead, the new canvass 1105 is active. Notice, the canvass metrics also now reflect the metrics associated with the new canvass 1105. There are 14,119 individuals targeted by this canvass and 7,324 households. This canvass also has 15 supporters or staff associated with it. The above processes can be performed even for existing canvasses. For instance, an existing canvass can be accessed, and the various different aspects of that canvass can be modified by performing the above operations on the existing canvass. Although the one canvass is currently greyed out and not active, a user can click on that canvass in the dashboard to activate it. Doing so will deactivate the canvass 1105. Furthermore, the metrics will be updated to reflect the metrics for the now-active canvass.

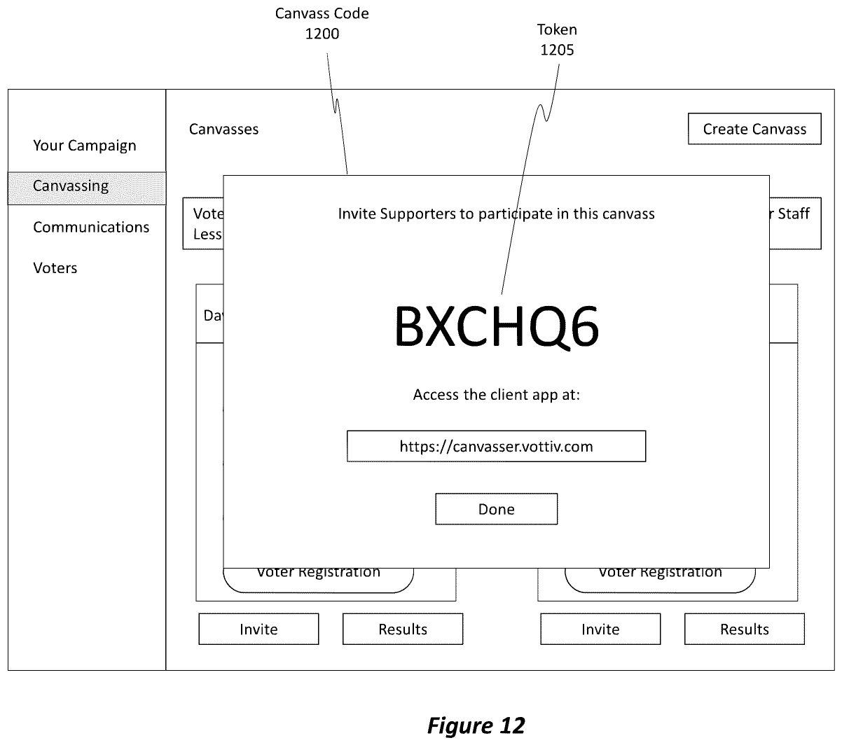

From this dashboard, the user can invite additional supporters or staff to be linked or engaged with the canvass 1105. For instance, by selecting the “Invite” option, the analysis service will trigger the generation of a shareable, executable token. This token can be presented to a supporter's device to link that device to the canvass 1105. FIG. 12 is illustrative.

In response to selecting the “Invite” button, the embodiments generate an executable token as shown within the canvass code 1200 menu. Specifically, the canvass code 1200 menu illustrates the token 1205.

In this example scenario, the token 1205 is shown as being a series of alphanumeric values. One will appreciate how other formats can be used, however. For instance, the token 1205 can be in the form of a quick response (QR) code or even a bar code.

In some cases, the same token is used for all supporter devices. That is, each supported involved in the same canvass will receive the same token.

In some cases, different tokens are used and are generated based on the identity of the supporter. Although the tokens may be different, those tokens all point to the same canvass.

For instance, a customized token linked to a specific supporter can be generated. When the supporter enters the customized token, the analysis service will be able to recognize what specific tasks this supporter has accomplished because that supporter's token can be associated with the tasks he/she completes. In this manner, the analysis service can track and record the productivity of the various supporters because those supporters can be differentiated based on the tokens they used to access the canvass. Each time a new supporter is desirous to be added to the canvass, the analysis service will generate a new token for that new supporter so that person can be linked to the canvass. Optionally, performance metrics can be displayed in the UI to indicate which supporters are most adept at completing the canvassing tasks.

This token 1205 is shareable with any number of other client or supporter devices. When the supporter enters this token 1205 into his/her device, that device will be paired with the canvass, and the supporter will be able to access the tasks that have been defined for the canvass. Under the guidance of the directions associated with those tasks, the user can then target the identified individuals in the canvass and attempt to perform the various tasks to completion.

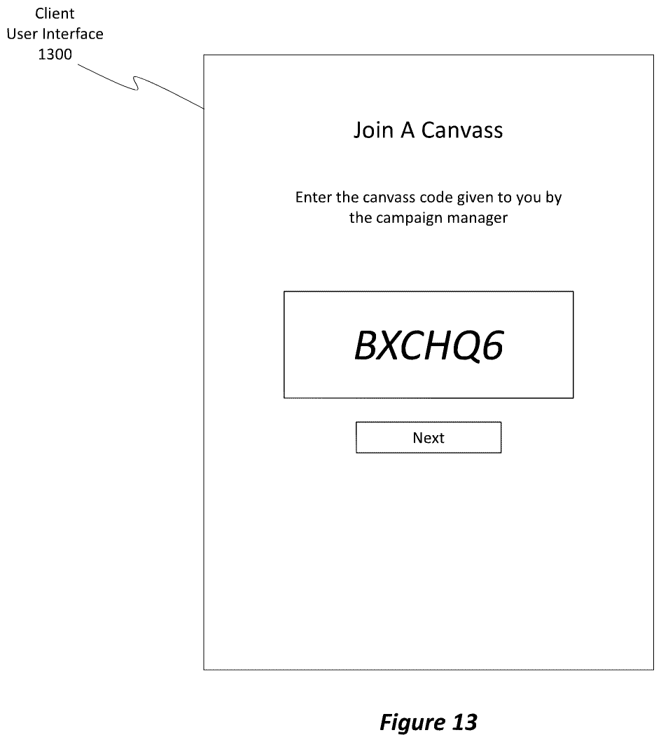

FIG. 13 shows a client-side user interface, labeled as client user interface 1300. The client UI 1300 is representative of the client UI 145 from FIG. 1. This client UI 1300 can be displayed in a client application executing on a supporter's device, such as perhaps a smart phone, tablet, laptop, and so on. The supporter has received the executable token and has entered that token into the client UI 1300.

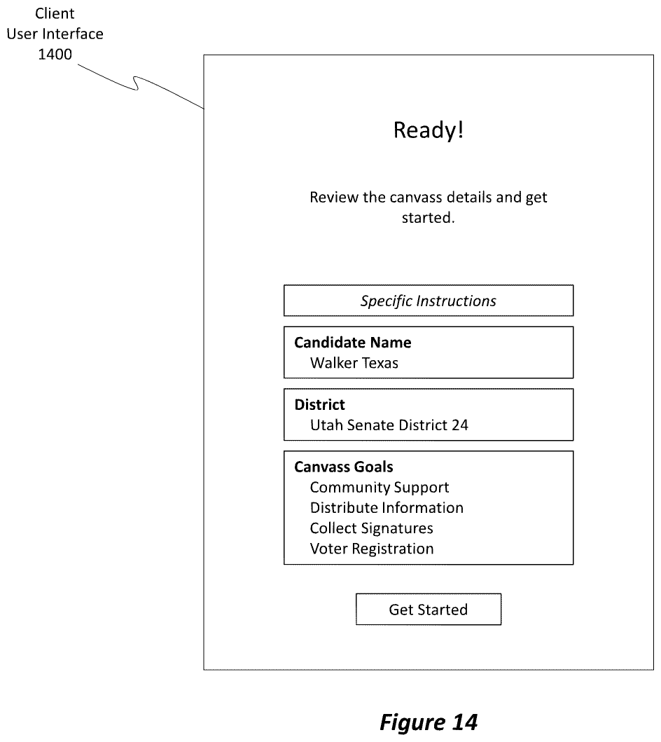

After entering the token, the supporter is then presented with the client UI 1400 of FIG. 14. In this UI, the supporter can observe the various details for the canvass. For instance, the supporter can read any specific instructions that have been provided, the political candidate's name who is being supported by the canvass (and/or the political issue that is being raised by the canvass), the district information, as well as the canvass goals or tasks. Recall, these canvass goals were defined earlier using the configuration user interface.

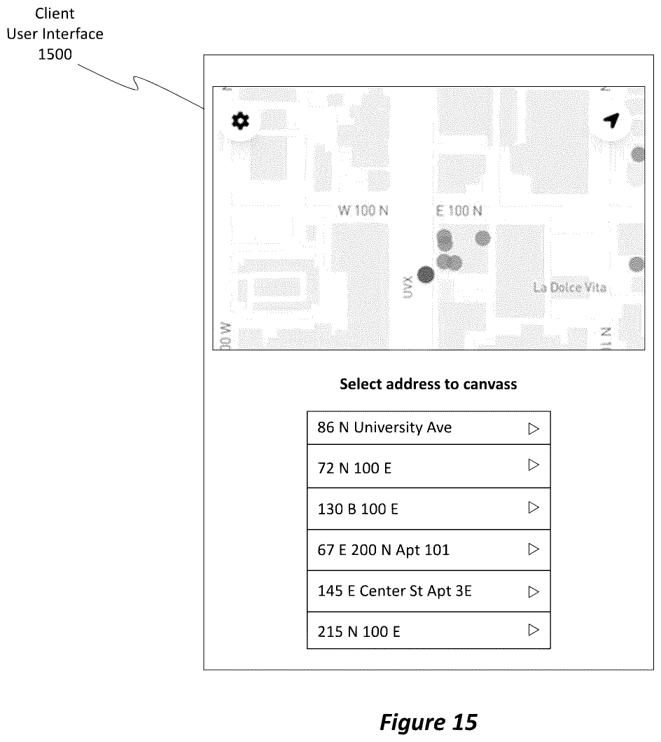

FIG. 15 shows a client UI 1500 where specific individuals, or rather households, who have been targeted by the canvass have an indicator displayed on a map. These identified individuals are those who were identified during the creation of the canvass based on the execution of the entered parameters (i.e. these targeted individuals are identified in the filtered data).

Currently, the map is zoomed in to a more localized region, but one will appreciate how the map can be zoomed in or out. The client UI 1500 is also currently displaying a list of addresses for the targeted individuals whose corresponding indicators are currently visible in the map. As the map is zoomed out and more targeted individuals are displayed in the map, the list of addresses will correspondingly increase.

The indicators in the map can be color coded or otherwise distinguished in order to represent a status of the corresponding individual or household. For instance, a first color can be used to indicate whether the individual was successfully contacted and canvassed. A second color can be used to indicate that the individual was contacted, but the individual was not receptive to the canvassing tasks. A third color can be used to indicate that the individual was not home. Different color schemes can be used to reflect the status. Of course, other visualization techniques can also be used to distinguish status, such as perhaps a blinking indicator, shape, or format.

By selecting a specific address in the client UI 1500, the client UI 1500 can generate a set of navigation instructions to direct the supporter to travel to the selected, targeted individual. Additionally, by selecting an address, the list of tasks can be generated to inform the supporter what he/she should present to the targeted individual.

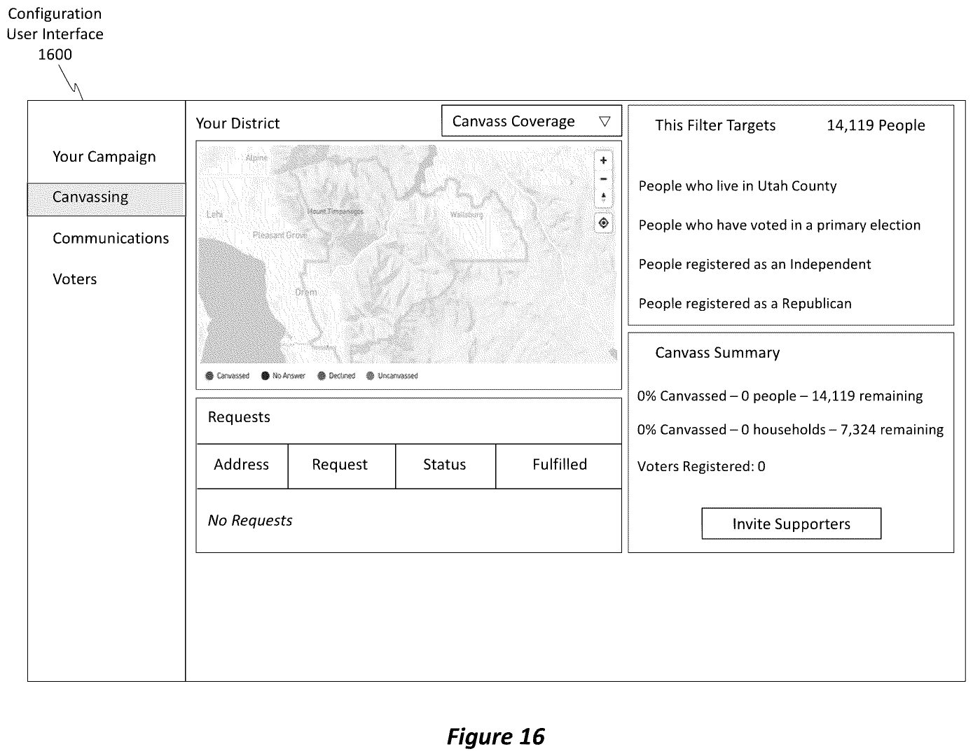

FIG. 16 shows a configuration UI 1600 showing a summary of the canvassing efforts of all of the supporters in reaching the targeted individuals. Optionally, the summary can be more granular. For instance, the summary can be configured to display the canvassing results of a particular supporter or perhaps a subset of selected supporters. Configuring the UI in this manner allows a user to observe which supporters are perhaps most effective or perhaps which regions are more receptive to canvassing supporters. If a particular area is identified as not being receptive or perhaps even dangerous (e.g., based on the collected canvassing metrics), a user can cordon, block, or isolate that area so that targeted individuals in that area are no longer canvassed. In one embodiment, a user can draw a boundary directly in the map and then select an option to have that bounded region no longer be subject to canvassing.

The UI shows a map of the selected location or district. The UI also shows any requests that targeted individuals may have submitted (currently, there are no requests). The UI also shows the filtering parameters associated with this canvass. To illustrate, this canvass is associated with the following parameters: (i) people who live in Utah county, (ii) people who have voted in a primary election, (iii) people registered as an independent, and (iv) people registered as a Republican. As mentioned previously, there are 14,119 people identified as being targeted individuals, and of those 14,119 targeted individuals, 0 or 0% of them have been canvassed. Similarly, there are 7,324 households, and of those 7,324 households, 0 or 0% of them have been canvassed. The map can be configured to display different attributes based on the collected metrics. Currently, the map is displaying the “Canvass Coverage” metric, but other metrics can be used. Such metrics include, but are not limited to, metrics based on age, gender, political party, receptiveness, and so on, without limit.

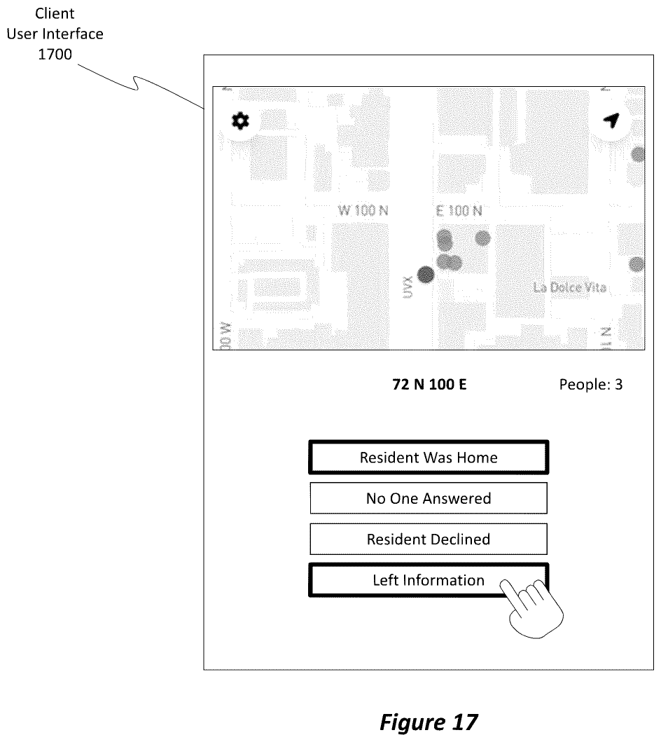

FIG. 17 shows an example client UI 1700. This client UI 1700 is illustrating a scenario where a specific target individual has been canvassed. As reflected by the bolded boundaries of the different buttons, this targeted individual was home (e.g., “Resident Was Home”) and the supporter was able to leave information (e.g., “Left Information”). In this household, there were 3 individuals who were canvassed.

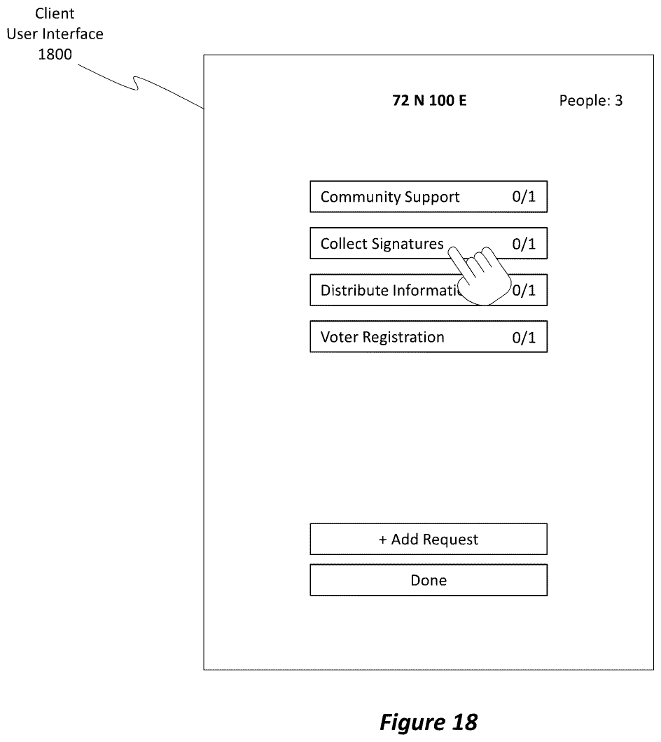

FIG. 1800 shows a resulting UI that can be displayed in response to the “Left Information” button being selected. In particular, client UI 1800 of FIG. 18 shows a number of tasks that can be marked as completed or not completed. Recall, these tasks were previously defined by the configuration UI. The client UI 1800 shows that the tasks include a “Community Support” task, a “Collect Signatures” task, a “Distribute Information” task, and a “Voter Registration” task. The supporter can attempt to complete each of the tasks with the targeted individual. If the targeted individual has specific requests, the supporter can select the “+ Add Request” option to enter that request. An example of a request can optionally be to have a sign placed in the targeted individual's lawn.

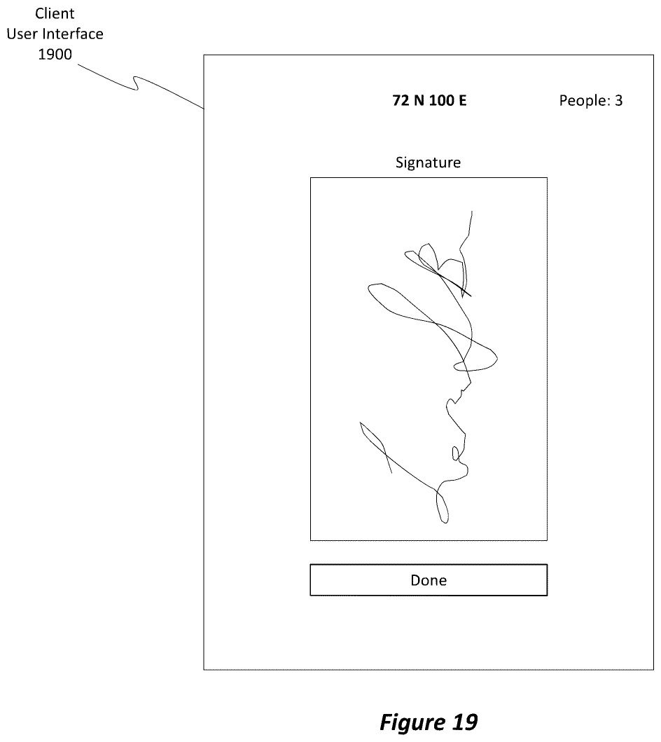

FIG. 19 shows a client UI 1900 that is displayed in response to the “Collect Signatures” task being selected. The UI will display the reason or details as to why signatures are being collected, and the UI will display an option for the targeted individual to use the touchscreen interface to input his/her signature, as shown in FIG. 19. Optionally, a copy of the reasons for the petition or cause along with the user's signature can be emailed, SMS text messaged, or otherwise provided to the individual who signed. Doing so enables the signer to have a copy of the data for his/her own records.

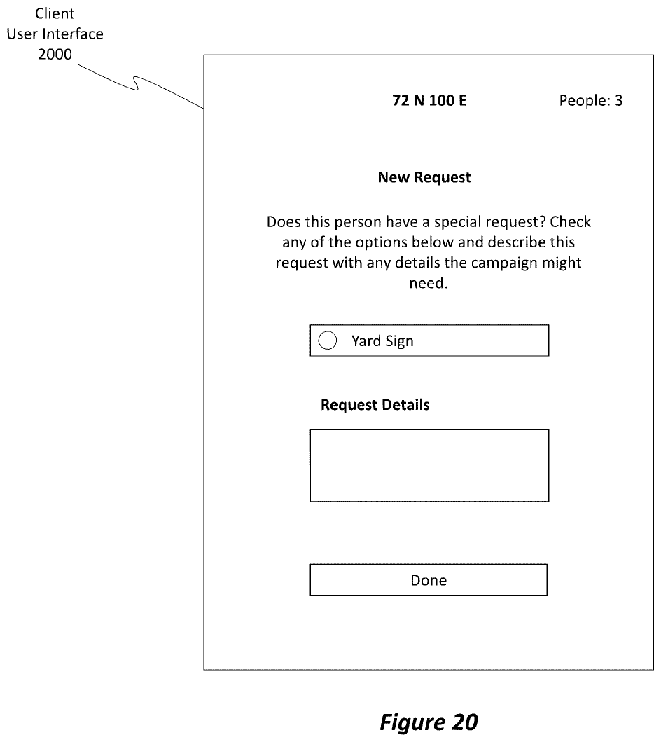

FIG. 20 shows a client UI 2000 that can be displayed when a targeted individual has a request. The targeted individual can optionally have a yard sign posted on his/her yard. Additional requests can also be entered via the client UI 2000.

### Group Communications

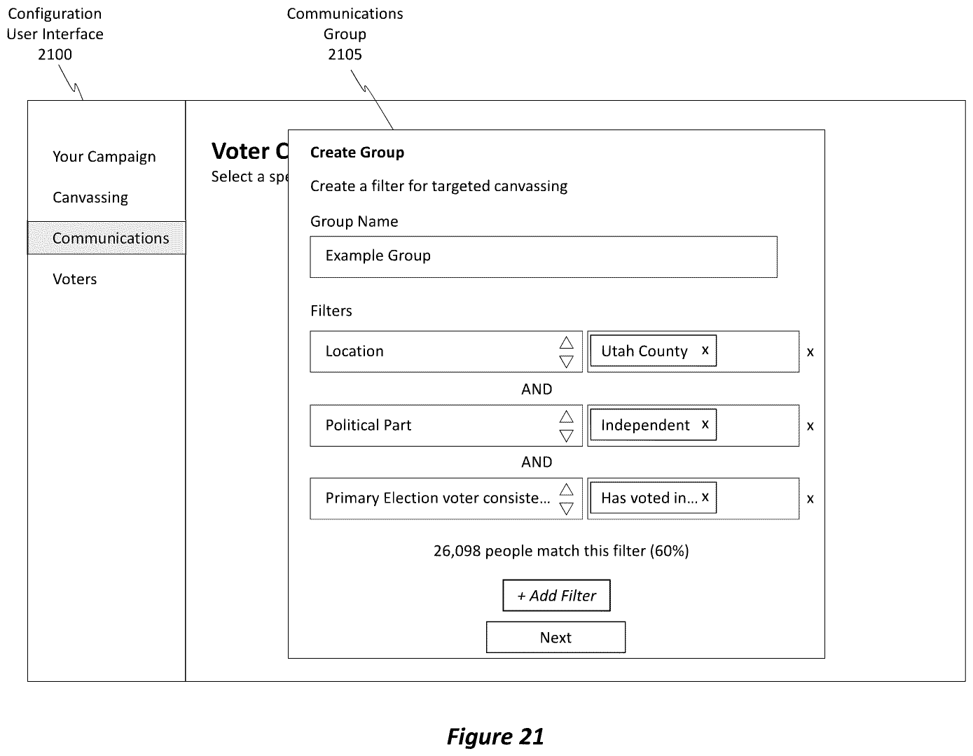

The embodiments are also able to provide an option for mass distribution of messages. FIG. 21 shows an example configuration UI 2100 where the “Communications” tab has been selected. Within this tab, the user can select an option to generate a group who will receive messages, as shown by the communications group 2105 menu.

In this menu, the user can define a group based on a selected set of filters, similar to the processes that were performed earlier to generate a canvass. In one embodiment, the group is linked or associated with a particular canvass. In another embodiment, the group can be entirely unique and separate from a canvass. If there is an overlap between the individuals in a group and individuals included in a canvass, the embodiments are able to provide a flag or indicator in the canvass database with regard to that individual so that the canvass can reflect that the individual has been contacted, even if that contact was for reasons not necessarily related to the canvass. This indicator can operate as a prediction indicator to gauge whether that individual will be receptive to additional canvassing operations. For instance, if the individual was upset he/she receive a message, then the embodiments can optionally tag or flag that individual's record in a canvass to indicate that he/she should not be targeted by canvassing tasks.

In the example shown in FIG. 21, the user has entered a set of parameters to select which targeted individuals are to receive a group communication. Based on the parameters, the number of individuals in this group is 26,098, or 60% of the district. In this example case, this group is not associated with a particular set of targeted individuals included in a canvass. Instead, this communications group can actually include multiple targeted individuals who might belong to multiple different canvasses. Thus, in this scenario, there is no connection between the specific communications group and a specific canvass. In some scenarios, however, a user can select and option to select all of the targeted individuals in a canvass and send messages to that group.

Some embodiments maintain metric data detailing how often individuals have been messaged. The embodiments can further include metric data detailing how receptive those individuals were to the messaging efforts. For instance, if a user responded to a message with a request to stop receiving future messages, then the embodiments can record and aggregate this information. If a user responded favorably, this information can be recorded as well. The success or failure of messaging campaigns can be tracked by the disclosed embodiments.

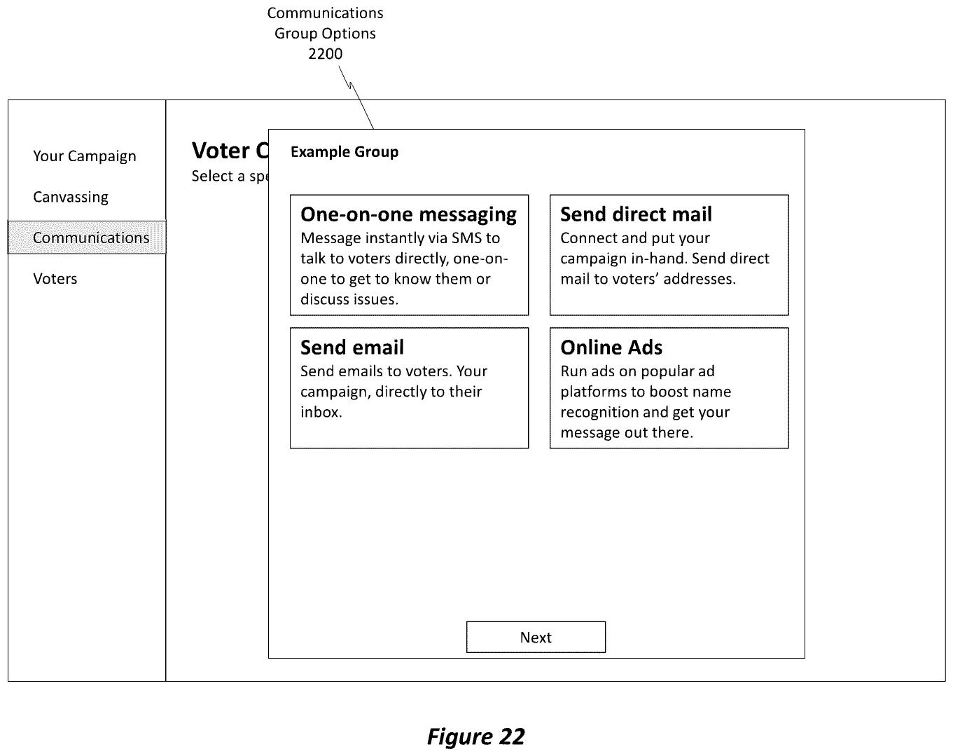

FIG. 22 shows a communications group options 2200 menu for selecting how to distribute a group message. This menu is shown as having four options, but one will appreciate how additional options can be made available.

These options include a one-on-one message via short message service (SMS) (e.g., a text message); a direct physical mail; an email; or an online advertisement. Responses to these messages can be received via the configuration UI, and a supporter can provide a further response to the targeted individuals.

Regarding the online advertisement option, any type of advertisement can be provided. Further, this advertisement can be provided to any platform. Examples of such platforms include any type of social media platform, video streaming service, search engine, and so on, without limit. Using this communications option, supporters can distribute mass messaging in an easy and efficient manner.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

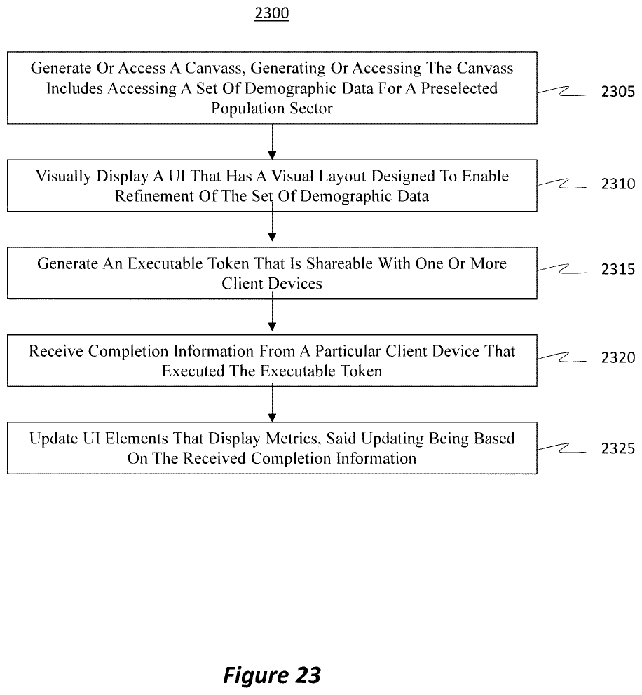

Attention will now be directed to FIG. 23, which illustrates a flowchart of an example method 2300 for (i) providing a canvassing user interface that has a particular visual layout designed to enable efficient refinement of demographic data to identify targeted individuals and to facilitate canvassing events, (ii) generating a set of canvassing tasks, and (iii) generating an executable token that links a client device to a particular canvass associated with the executable token. Method 2300 can be implemented within the architecture 100 of FIG. 1. Further, method 2300 can be performed by the analysis service 105A of FIG. 1. In scenarios where the analysis service 105A is a cloud service, then the method 2300 can be performed by the cloud service.

Initially, method 2300 includes an act (act 2305) of generating or accessing a canvass. A new canvass can be generated, or an existing canvass can be accessed. An existing canvass can be accessed if that canvass is to be updated with new parameters. Generating or accessing the canvass includes accessing a set of demographic data for a preselected population sector, as defined by a parameter that is included as a part of the canvass. In some implementations, the set of demographic data includes inferred demographic data comprising information that is inferred from a base set of demographic data. In some cases, a machine learning engine performs machine learning on the set of demographic data to generate one or more inferences based on the set of demographic data.

The demographic data can be updated based on a predefined event. The predefined event can include an event in which the canvass is first generated. In some cases, the predefined event can include an event in which a defined period of time has elapsed since a time when the canvass was first generated.

The cloud service can ingest the set of demographic data and optionally generate an inference based on the set of demographic data. In some cases, the cloud service can include a machine learning (ML) engine, and the ML engine can use machine learning to generate the inference. In some cases, the inference was generated prior to the cloud service ingesting the data.

In some embodiments, the demographic data is accessed and then downloaded locally. The specific data that is downloaded is initially based on or is filtered using a specified location parameter.

Act 2310 includes visually displaying, as a part of generating or accessing the canvass, a user interface (UI) that has a visual layout designed to enable refinement of the set of demographic data. Notably, this refinement results in the identification of a target set of individuals within the preselected population sector. Information about these targeted individuals will be linked to the canvass.

In some embodiments, the visual layout includes a first set of selectable UI elements that, when selected, generate parameters. The parameters operate on the set of demographic data to further filter the set of demographic data. Notably, the initial corpus of data was filtered based on location, but the data can be further filtered based on additional parameters. As a result, a filtered set of data is generated, and the filtered set of data is associated with the canvass. The filtered data includes data identifying the targeted individuals (i.e. the filtered set of data identifies the target set of individuals).

The visual layout can further include a second set of selectable UI elements that, when selected, generate a set of one or more canvassing tasks for the canvass. For instance, FIG. 8 illustrated some example canvassing tasks that can be defined. Such tasks can include, but certainly are not limited to, a task comprising collection of support data for a particular entity, a task comprising distribution of information describing a particular entity, a task comprising a collection of a signature for a defined cause, or even a task comprising assistance in registering for a service (e.g., perhaps voter registration) or event. Of course, other tasks can be defined as well.

The visual layout can further include a third set of UI elements that display metrics for the canvass. The displayed metrics can visually indicate a respective completion status for each canvassing task in the set. For instance, FIG. 2 showed the canvass metrics 210 for the canvass named “Davis County Republicans Who Vote.” In some cases, the displayed metrics can display how many targeted individuals are included in the canvass and what that number is relative to the population of the entire location. In some cases, the metrics can include the number of households that are included in the canvass and what that number is relative to the total number of households in the entire location. In some cases, the metrics can include information about the supporters associated with the canvass. Optionally, the metrics can include success or failure rates for specific supporters. In some cases, the metrics can indicate what specific areas in the overall location or more or less receptive to the canvassing.

In some embodiments, the displayed metrics include a first metric listing a percentage of individuals who have been canvassed as a result of the set of canvassing tasks being performed, and a second metric listing a number of individuals who have been canvassed. Here, the first metric and the second metric are displayed within the UI simultaneously with one another.

In some embodiments, the displayed metrics include a first metric listing a percentage of households that have been canvassed as a result of the set of canvassing tasks being performed, and a second metric listing a number of households that have been canvassed. Here, the first metric and the second metric are displayed within the UI simultaneously with one another.

The visual layout can further include a fourth set of UI elements that includes one or more of (i) a first option that facilitates transmission of a short message service (SMS) message being delivered to specific individuals (e.g., perhaps individuals who are included in the set of targeted individuals); (ii) a second option that facilitates transmission of an email message being delivered to the specific individuals; (iii) a third option that facilitates transmission of physical mail being mailed to the specific individuals; or (iv) a fourth option that facilitates posting of advertisements to the specific individuals. For instance, the communications group options 2200 menu showed some of these different communication options.

Act 2315 includes generating an executable token (e.g., token 140 from FIG. 1) that is shareable with one or more client devices. The executable token is structured such that, when executed by a client device, the client device is provided access to the set of canvassing tasks for the canvass. In some embodiments, the executable token is one of an alphanumeric code, a quick response (QR) code, or a bar code. For instance, FIG. 13 shows a scenario where a client UI 1300 is currently being displayed on a client device. The supporter of the canvass has entered the token into the client UI 1300, and the supporter is now able to access the tasks of the canvass as well as some additional information included in the canvass.

Act 2320 includes receiving completion information from a particular client device that executed the executable token. The completion information reflects completion statuses for the set of canvassing tasks. For instance, as the supporters canvass the targeted individuals, the supporters can use the client UI 1700 of FIG. 17 to indicate what tasks and actions have been performed. This data is transmitted from the supporter's device to the analysis service, which then compiles and aggregates the information.

Act 2325 includes updating the third set of UI elements that display the metrics. This updating process is based on the received completion information. For instance, as data is received from the supporters' devices, the analysis service will update the canvass metrics 210 of FIG. 2. As more individuals and more households are canvassed, the metrics will be updated.

In some cases, the UI can be configured to further display a map showing a boundary of a district associated with the preselected population sector. Optionally, the map can include display elements visually illustrating locations where the target set of individuals are located. Optionally, the UI can be further configured to indicate a number of individuals who are included in the target set of individuals.

Accordingly, the disclosed embodiments are able to generate a canvass that identifies a set of target individuals and that generates tasks. In doing so, significant benefits can be achieved in how political campaigns are managed. The disclosed embodiments are beneficially able to track and monitor which individuals have been canvassed and can visually display indicators reflective of this status. Furthermore, the disclosed embodiments include the use of a user interface having a particular visual layout. This visual layout is designed to help improve the user's interaction with a computer system to facilitate the efficient performance of the defined tasks.

### Example Computer/Computer Systems

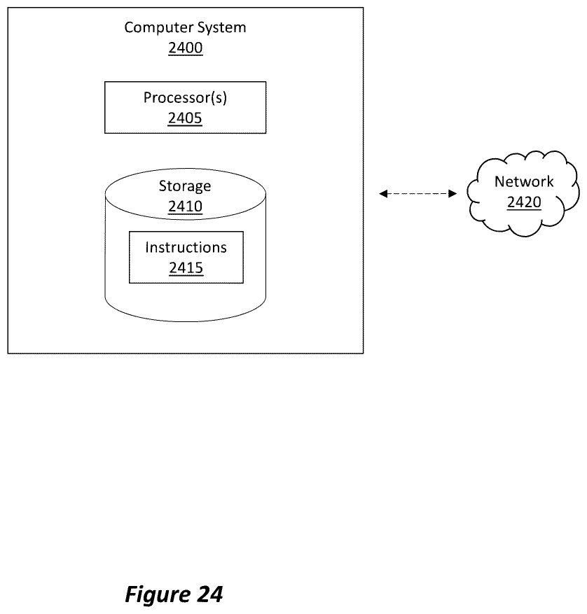

Attention will now be directed to FIG. 24 which illustrates an example computer system 2400 that may include and/or be used to perform any of the operations described herein. For instance, the analysis service 105A of FIG. 1 can be implemented using the computer system 2400. Computer system 2400 may take various different forms. For example, computer system 2400 may be embodied as a tablet, a desktop, a laptop, a mobile device, or a standalone device, such as those described throughout this disclosure. Computer system 2400 may also be a distributed system that includes one or more connected computing components/devices that are in communication with computer system 2400.

In its most basic configuration, computer system 2400 includes various different components. FIG. 24 shows that computer system 2400 includes one or more processor(s) 2405 (aka a “hardware processing unit”) and storage 2410.

Regarding the processor(s) 2405, it will be appreciated that the functionality described herein can be performed, at least in part, by one or more hardware logic components (e.g., the processor(s) 2405). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 2400. The different components, modules, engines, and services described herein may be implemented as objects or processors that execute on computer system 2400 (e.g. as separate threads).

Storage 2410 may be physical system memory, which may be volatile, non-volatile, or some combination of the two. The term “memory” may also be used herein to refer to non-volatile mass storage such as physical storage media. If computer system 2400 is distributed, the processing, memory, and/or storage capability may be distributed as well.

Storage 2410 is shown as including executable instructions 2415. The executable instructions 2415 represent instructions that are executable by the processor(s) 2405 of computer system 2400 to perform the disclosed operations, such as those described in the various methods.

The disclosed embodiments may comprise or utilize a special-purpose or general-purpose computer including computer hardware, such as, for example, one or more processors (such as processor(s) 2405) and system memory (such as storage 2410), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2400 may also be connected (via a wired or wireless connection) to external sensors (e.g., one or more remote cameras) or devices via a network 2420. For example, computer system 2400 can communicate with any number devices or cloud services to obtain or process data. In some cases, network 2420 may itself be a cloud network. Furthermore, computer system 2400 may also be connected through one or more wired or wireless networks to remote/separate computer systems(s) that are configured to perform any of the processing described with regard to computer system 2400.

A “network,” like network 2420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2400 will include one or more communication channels that are used to communicate with the network 2420. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for (i) providing a canvassing user interface that has a particular visual layout designed to enable efficient refinement of demographic data to identify targeted individuals and to facilitate canvassing events, (ii) generating a set of canvassing tasks, and (iii) generating an executable token that links a client device to a particular canvass associated with the executable token, said method comprising:
generating or accessing a canvass, wherein generating or accessing the canvass includes accessing a set of demographic data for a preselected population sector;
as a part of generating or accessing the canvass, visually displaying a user interface (UI) that has a visual layout designed to enable refinement of the set of demographic data, said refinement resulting in identification of a target set of individuals within the preselected population sector, wherein the visual layout includes:
a first set of selectable UI elements that, when selected, generate parameters, wherein the parameters operate on the set of demographic data to filter the set of demographic data such that a filtered set of data is generated, wherein the filtered set of data is associated with the canvass, and wherein the filtered set of data identifies the target set of individuals;
a second set of selectable UI elements that, when selected, generate a set of one or more canvassing tasks for the canvass; and
a third set of UI elements that display metrics for the canvass, wherein the displayed metrics visually indicate a respective completion status for each canvassing task in the set of one or more canvassing tasks;
generating an executable token that is shareable with one or more client devices, wherein the executable token is structured such that, when executed by a client device, the client device is provided access to the set of one or more canvassing tasks for the canvass;
receiving completion information from a particular client device that executed the executable token, wherein the completion information reflects completion statuses for the set of one or more canvassing tasks; and
updating the third set of UI elements that display the metrics, said updating being based on the received completion information.

2. The method of claim 1, wherein the set of demographic data is updated based on a predefined event that includes an event in which the canvass is first generated.

3. The method of claim 1, wherein the set of demographic data is updated based on a predefined event that includes an event in which a defined period of time has elapsed since a time when the canvass was first generated.

4. The method of claim 1, wherein the method is performed by a cloud service, and wherein the cloud service ingests the set of demographic data and generates an inference based on the set of demographic data.

5. The method of claim 4, wherein the cloud service includes a machine learning engine, and wherein the machine learning engine uses machine learning to generate the inference.

6. The method of claim 1, wherein the set of one or more canvassing tasks includes a task comprising collection of support data for a particular entity.

7. The method of claim 1, wherein the set of one or more canvassing tasks includes a task comprising distribution of information describing a particular entity.

8. The method of claim 1, wherein the set of one or more canvassing tasks includes a task comprising a collection of a signature for a defined cause.

9. The method of claim 1, wherein the set of one or more canvassing tasks includes a task comprising assistance in registering for a service or event.

10. The method of claim 1, wherein the UI further displays a map showing a boundary of a district associated with the preselected population sector, and wherein the map includes display elements visually illustrating locations where the target set of individuals are located.

11. A computer system that (i) provides a canvassing user interface that has a particular visual layout designed to enable efficient refinement of demographic data to identify targeted individuals and to facilitate canvassing events, (ii) generates a set of canvassing tasks, and (iii) generates an executable token that links a client device to a particular canvass associated with the executable token, said computer system comprising:
one or more processors; and
one or more hardware storage devices that store instructions that are executable by the one or more processors to cause the computer system to:
generate or access a canvass, wherein generating or accessing the canvass includes accessing a set of demographic data for a preselected population sector;
as a part of generating or accessing the canvass, visually display a user interface (UI) that has a visual layout designed to enable refinement of the set of demographic data, said refinement resulting in identification of a target set of individuals within the preselected population sector, wherein the visual layout includes:
a first set of selectable UI elements that, when selected, generate parameters, wherein the parameters operate on the set of demographic data to filter the set of demographic data such that a filtered set of data is generated, wherein the filtered set of data is associated with the canvass, and wherein the filtered set of data identifies the target set of individuals;
a second set of selectable UI elements that, when selected, generate a set of one or more canvassing tasks for the canvass; and
a third set of UI elements that display metrics for the canvass, wherein the displayed metrics visually indicate a respective completion status for each canvassing task in the set of one or more canvassing tasks;
generate an executable token that is shareable with one or more client devices, wherein the executable token is structured such that, when executed by a client device, the client device is provided access to the set of one or more canvassing tasks for the canvass;
receive completion information from a particular client device that executed the executable token, wherein the completion information reflects completion statuses for the set of one or more canvassing tasks; and
update the third set of UI elements that display the metrics, said updating being based on the received completion information.

12. The computer system of claim 11, wherein the displayed metrics include a first metric listing a percentage of individuals who have been canvassed as a result of the set of one or more canvassing tasks being performed and a second metric listing a number of individuals who have been canvassed, and wherein the first metric and the second metric are displayed within the UI simultaneously with one another.

13. The computer system of claim 11, wherein the displayed metrics include a first metric listing a percentage of households that have been canvassed as a result of the set of one or more canvassing tasks being performed and a second metric listing a number of households that have been canvassed, and wherein the first metric and the second metric are displayed within the UI simultaneously with one another.

14. The computer system of claim 11, wherein the UI further indicates a number of individuals who are included in the target set of individuals.

15. The computer system of claim 11, wherein the visual layout of the UI further includes a communications tab, and wherein the communications tab includes all of:
a first option that facilitates transmission of a short message service (SMS) message being delivered to specific individuals;
a second option that facilitates transmission of an email message being delivered to the specific individuals;
a third option that facilitates transmission of physical mail being mailed to the specific individuals; and
a fourth option that facilitates posting of advertisements to the specific individuals.

16. The computer system of claim 11, wherein the executable token is one of an alphanumeric code, a quick response (QR) code, or a bar code.

17. The computer system of claim 11, wherein the set of demographic data includes inferred demographic data comprising information that is inferred from a base set of demographic data.

18. A method for (i) providing a canvassing user interface that has a particular visual layout designed to enable efficient refinement of demographic data to identify targeted individuals and to facilitate canvassing events, (ii) generating a set of canvassing tasks, and (iii) generating an executable token that links a client device to a particular canvass associated with the executable token, said method comprising:
generating or accessing a canvass, wherein generating or accessing the canvass includes accessing a set of demographic data for a preselected population sector;
as a part of generating or accessing the canvass, visually displaying a user interface (UI) that has a visual layout designed to enable refinement of the set of demographic data, said refinement resulting in identification of a target set of individuals within the preselected population sector, wherein the visual layout includes:
a first set of selectable UI elements that, when selected, generate parameters, wherein the parameters operate on the set of demographic data to filter the set of demographic data such that a filtered set of data is generated, wherein the filtered set of data is associated with a canvass, and wherein the filtered set of data identifies the target set of individuals;
a second set of selectable UI elements that, when selected, generate a set of one or more canvassing tasks for the canvass;
a third set of UI elements that display metrics for the canvass, wherein the displayed metrics visually indicate a respective completion status for each canvassing task in the set of one or more canvassing tasks; and
a fourth set of UI elements that includes one or more of:
a first option that facilitates transmission of a short message service (SMS) message being delivered to specific individuals;
a second option that facilitates transmission of an email message being delivered to the specific individuals;
a third option that facilitates transmission of physical mail being mailed to the specific individuals; and
a fourth option that facilitates posting of advertisements to the specific individuals;
generating an executable token that is shareable with one or more client devices, wherein the executable token is structured such that, when executed by a client device, the client device is provided access to the set of one or more canvassing tasks for the canvass;
receiving completion information from a particular client device that executed the executable token, wherein the completion information reflects completion statuses for the set of one or more canvassing tasks; and
updating the third set of UI elements that display the metrics, said updating being based on the received completion information.

19. The method of claim 18, wherein a machine learning engine performs machine learning on the set of demographic data to generate one or more inferences based on the set of demographic data.

20. The method of claim 18, wherein the set of demographic data is updated based on a predefined event that includes an event in which a defined period of time has elapsed since a time when the canvass was first generated.
